(19) United States
(12) Patent Application Publication
(10) Pub. No.: US 2014/0340425 A1
(43) Pub. Date: Nov. 20, 2014

(54) DISPLAY CONTROL APPARATUS, CONTROL METHOD OF DISPLAY CONTROL APPARATUS, AND STORAGE MEDIUM

(71) Applicant: CANON KABUSHIKI KAISHA, Tokyo (JP)

(72) Inventor: Takenori TSUKIKAWA, Kawasaki-shi (JP)

(73) Assignee: CANON KABUSHIKI KAISHA, Tokyo (JP)

(21) Appl. No.: 14/278,359

(22) Filed: May 15, 2014

(30) Foreign Application Priority Data
May 20, 2013 (JP) 2013-106591

(51) Int. Cl. G09G 5/14

(52) U.S. Cl. CPC G09G 5/14; G09G 2340/10; G09G 2340/12
USPC 345/634

(57) ABSTRACT

A display control apparatus comprises a discrimination unit configured to discriminate a feature of an image group based on a relation between images that belong to the image group; a determination unit configured to determine a display form for the image group according to the feature discriminated by the discrimination unit; and a display control unit configured to cause the image group to be displayed in the display form determined by the determination unit.

### BACKGROUND OF THE INVENTION

1. Field of the Invention

The present invention relates to a display control apparatus, a control method of a display control apparatus, and a storage medium.

2. Description of the Related Art

One example of a method for presenting a large number of images in an easily viewable manner is a method of grouping a large number of images according to a specific condition and changing the presentation method according to whether or not images belong to a group. Japanese Patent Laid-Open No. 2006-94284 discloses a technique for grouping together images that were captured consecutively and distinguishing between the consecutively captured images and other images.

Also, as an example of a method of presenting images to a user who is attempting to select a specific image from among a large number of images, there is a technique for changing the image presentation method based on information obtained from the images. Japanese Patent Laid-Open No. 2010-79570 discloses a technique for using the relative positional relation between the main subject in an image and the image capture apparatus to change the arrangement of images and change the image presentation method.

There is also a technique in which images in an image group resulting from grouping are collectively subjected to image processing. For example, Japanese Patent Laid-Open No. 2000-215322 proposes a method of selecting any one image from an image group made up of images classified into a group, performing image processing on the selected image, and executing processing similar to that image processing on all of the images in the group.

However, although the method disclosed in Japanese Patent Laid-Open No. 2006-94284 improves viewability for the image group as a whole, this does not assist the selection of an image from among a large number of images.

Also, although the method disclosed in Japanese Patent Laid-Open No. 2010-79570 changes the arrangement and sizes of images based on the relation between the image capture apparatus and the captured images, this does not assist the selection of an image from among a large number of images.

Furthermore, with the method disclosed in Japanese Patent Laid-Open No. 2000-215322, images that have been grouped according to a specific condition are collectively subjected to image processing. However, since the image processing is processing for editing and changing the image itself, it is not possible to alleviate the processing burden borne by a user attempting to select an image from among a large number of images.

In light of the above situation, the present invention provides a technique for alleviating the operation load borne by the user and improving the task efficiency when selecting an image from among a large number of images.

### SUMMARY OF THE INVENTION

According to one aspect of the present invention, there is provided a display control apparatus comprising: a discrimination unit configured to discriminate a feature of an image group based on a relation between images that belong to the image group; a determination unit configured to determine a display form for the image group according to the feature discriminated by the discrimination unit; and a display control unit configured to cause the image group to be displayed in the display form determined by the determination unit.

Further features of the present invention will be apparent from the following description of exemplary embodiments with reference to the attached drawings.

### BRIEF DESCRIPTION OF THE DRAWINGS

FIG. 1 is a diagram showing an example of a functional configuration of an image display apparatus according to a first embodiment of the present invention.

FIG. 2 is a diagram showing an example of a tabular image display displayed by an image display unit according to the first embodiment of the present invention.

FIG. 3 is a flowchart showing a procedure of processing executed by an image group feature discrimination unit according to the first embodiment of the present invention.

FIG. 4 is a flowchart showing a procedure of processing executed by a display form determination unit according to the first embodiment of the present invention.

FIG. 5 is a diagram showing an example of a panorama display form according to the first embodiment of the present invention.

FIG. 6 is a diagram showing an example of a comparison display form according to the first embodiment of the present invention.

FIG. 7 is a diagram showing an example of a tabular display form according to the first embodiment of the present invention.

FIG. 8 is a diagram showing an example of a functional configuration of an image display apparatus according to a second embodiment of the present invention.

FIG. 9 is a flowchart showing a procedure of processing executed by a display form switching unit according to the second embodiment of the present invention.

FIG. 10 is a diagram showing an example of a functional configuration of an image display apparatus according to a third embodiment of the present invention.

FIG. 11 is a flowchart showing a procedure of processing executed by an image classification unit according to the third embodiment of the present invention.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

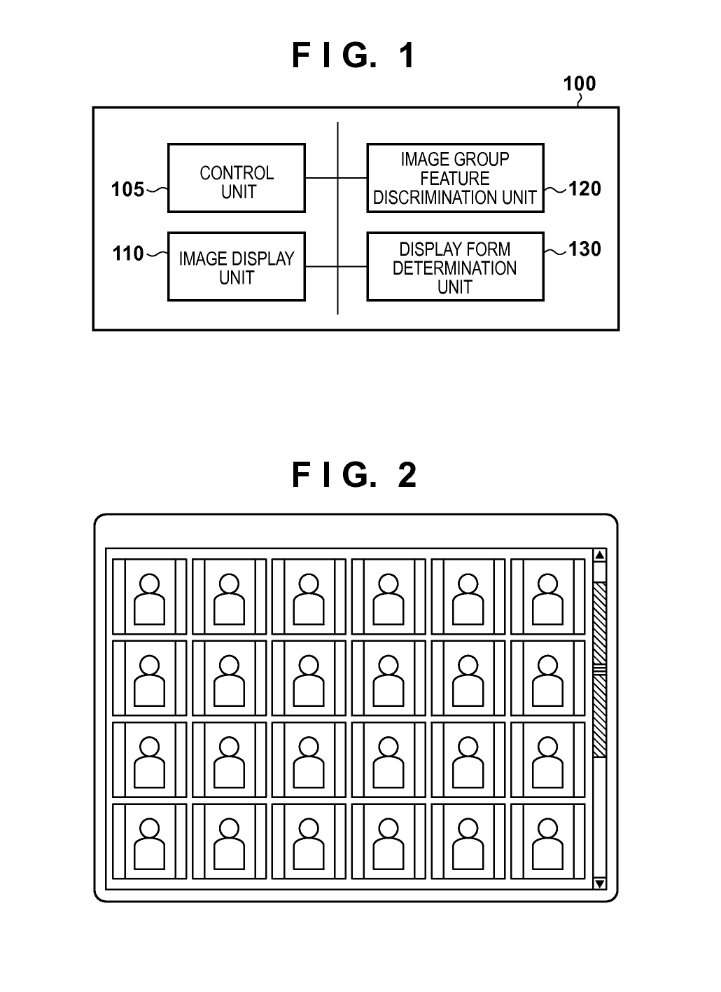

FIG. 1 is a diagram showing an example of the functional configuration of an image display apparatus 100 according to a first embodiment of the present invention. The image display apparatus 100 discriminates features of image groups, determines a most appropriate display form for each image group, and displays an image selected by a user in the display form determined for the image group to which the selected image belongs. The image display apparatus 100 includes a control unit 105, an image display unit 110, an image group feature discrimination unit 120, and a display form determination unit 130.

A program for causing a CPU (not shown) to realize processing according to various embodiments is stored in a memory, and the control unit 105 controls the operation of various processing units by reading out the program from the memory and executing it. The image display unit 110 displays a confirmation image group, which is a parent population for when the user selects an image. The confirmation image group is displayed in a tabular display form as shown in FIG. 2, for example. The image group feature discrimination unit 120 analyzes the inter-image relation between images that belong to an image group and discriminates a feature of that image group. The display form determination unit 130 determines an appropriate display form for when the user is to select an image from the confirmation image group, based on the feature of the image group that was discriminated by the image group feature discrimination unit 120.

Processing of Image Group Feature Discrimination Unit 120

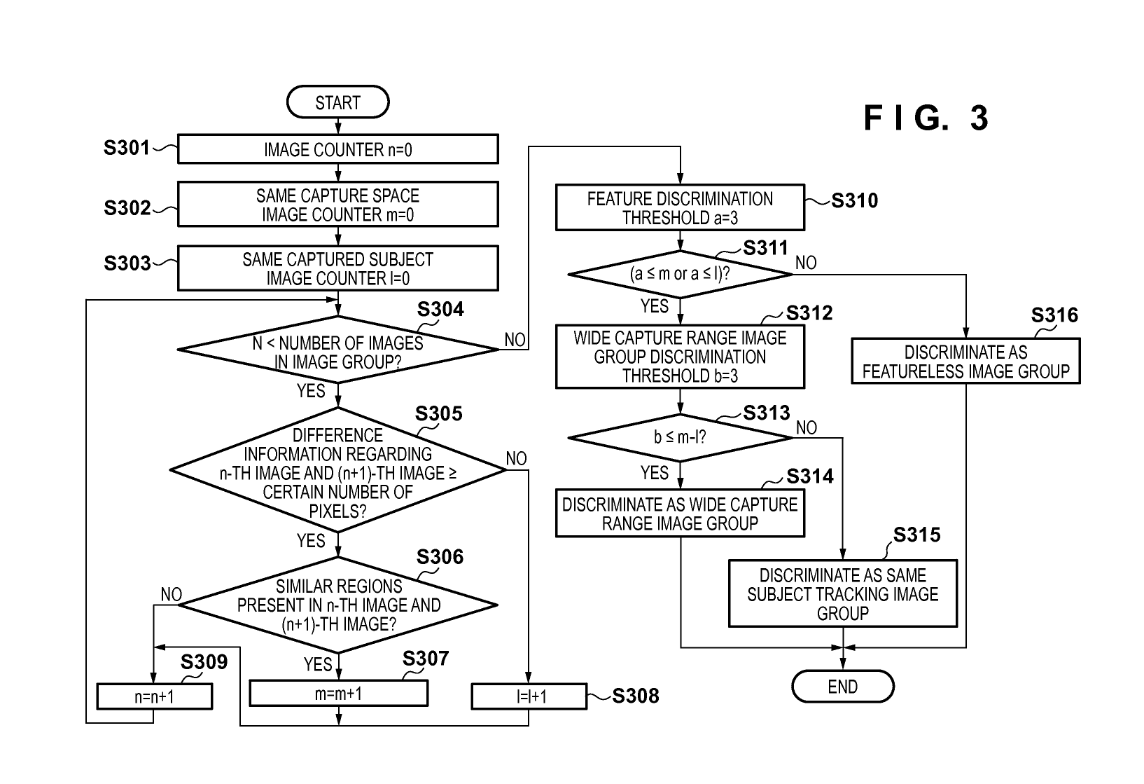

Next, the processing executed by the image group feature discrimination unit 120 will be described in detail. The image group feature discrimination unit 120 performs processing for analyzing the inter-image relation between images that belong to an image group and discriminating a feature of that image group. FIG. 3 is a flowchart showing a procedure of processing for analyzing the inter-image relation between images that belong to an image group and discriminating a feature of that image group. Note that in the example in FIG. 3, the feature of an image group is discriminated by, for each pair of images belonging to the image group, extracting the difference between the two images and analyzing the inter-image relation using the result of the difference extraction. However, the criterion for discriminating the feature of an image group is not necessarily limited to difference information extracted using pairs of images that belong to the image group.

First, in step S301, the image group feature discrimination unit 120 sets an image counter n to 0. In step S302, the image group feature discrimination unit 120 sets a same capture space image counter m to 0. In step S303, the image group feature discrimination unit 120 sets a same captured subject image counter l to 0.

Thereafter, in step S304, the image group feature discrimination unit 120 determines whether or not the value of the image counter n is smaller than the number of images in the image group. If the value of n is smaller than the number of images in the image group (step S304: YES), the procedure moves to step S305. On the other hand, if the value of n is greater than or equal to the number of images in the image group (step S304: NO), the procedure moves to step S310.

In step S305, the image group feature discrimination unit 120 extracts difference information regarding the n-th image in the image group (n being the value of the image counter n) and the (n+1)-th image in the image group (n+1 being the value of the image counter n plus 1), and determines whether or not the difference information is greater than or equal to a certain number of pixels. If it was determined that the difference information is greater than or equal to the certain number of pixels (step S305: YES), the procedure moves to step S306. On the other hand, if it was determined that the difference information is less than the certain number of pixels (step S305: NO), the procedure moves to step S308.

In step S306, the image group feature discrimination unit 120 determines whether similar regions are present in the n-th image and the (n+1)-th image (presence/absence of a similar region). If it was determined that similar regions are present (step S306: YES), a relation exists between the n-th image and the (n+1)-th image, and therefore the procedure moves to step S307. On the other hand, if it was determined that similar regions are not present (step S306: NO), a relation does not exist between the n-th image and the (n+1)-th image, and therefore the procedure moves to step S309.

In step S307, the image group feature discrimination unit 120 determines that the (n+1)-th image was captured in the same space as the n-th image and adds 1 to the value of the same capture space image counter m. The procedure then moves to step S309.

In step S308, the image group feature discrimination unit 120 determines that the (n+1)-th image includes the same captured subject as the n-th image and adds 1 to the value of the same captured subject image counter l. The procedure then moves to step S309. In step S309, the image group feature discrimination unit 120 adds 1 to the value of the image counter n, and then the procedure returns to the processing of step S304.

In step S310, the image group feature discrimination unit 120 sets a feature discrimination threshold a to 3. Note that the value of the feature discrimination threshold a is not limited to 3, and can be changed to any value.

In step S311, the image group feature discrimination unit 120 determines whether the value of the same capture space image counter m or the value of the same captured subject image counter l is greater than or equal to the feature discrimination threshold a. If it was determined that the value of m or the value of l is greater than or equal to the feature discrimination threshold a (step S311: YES), the procedure moves to step S312. On the other hand, if it was determined that both the value of m and the value of l are less than the feature discrimination threshold a (step S311: NO), the procedure moves to step S316.

In step S312, the image group feature discrimination unit 120 sets a wide capture range image group discrimination threshold b to 3. Note that the value of the wide capture range image group discrimination threshold b is not limited to 3, and can be changed to any value.

In step S313, the image group feature discrimination unit 120 determines whether or not the difference between the same capture space image counter m and the same captured subject image counter l is greater than or equal to the wide capture range image group discrimination threshold b. If it was determined that the difference between m and l is greater than or equal to b (step S313: YES), the procedure moves to step S314. On the other hand, if it was determined that the difference between m and l is less than b (step S313: NO), the procedure moves to step S315.

In step S314, the image group feature discrimination unit 120 discriminates that the image group being discriminated is a wide capture range image group. The wide capture range image group referred to here is, for example, an image group that includes multiple images captured with different camera angles when capturing a landscape photograph in which the subject to be captured does not fit in the angle of view of the camera.

In step S315, the image group feature discrimination unit 120 discriminates that the image group being discriminated is a same subject tracking image group. The same subject tracking image group referred to here is, for example, an image group that includes images captured consecutively while following a subject in the case of capturing a subject that is in motion.

In step S316, the image group feature discrimination unit 120 discriminates that the image group being discriminated is a featureless image group. After the processing of step S314, S315, or S316 has been performed, the processing in the flowchart of FIG. 3 ends.

Processing of display form determination unit 130

Next, the processing executed by the display form determination unit 130 will be described in detail. The display form determination unit 130 performs processing for determining the form in which images are to be displayed using the discrimination result obtained by the image group feature discrimination unit 120. FIG. 4 is a flowchart showing a procedure of processing for determining a display form based on the feature of an image group.

First, in step S401, the display form determination unit 130 determines whether or not the image group is a wide capture range image group. If it was determined that the image group is a wide capture range image group (step S401: YES), the procedure moves to step S402. On the other hand, if it was determined that the image group is not a wide capture range image group (step S401: NO), the procedure moves to step S403.

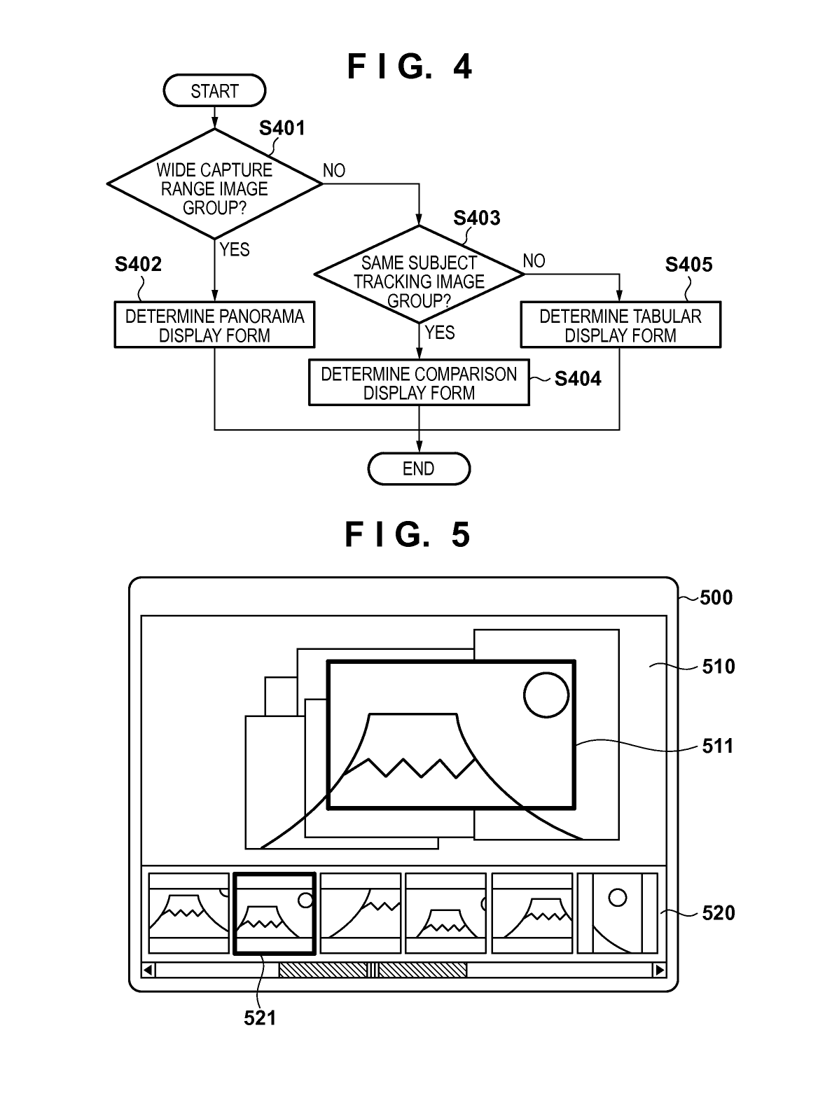

In step S402, the display form determination unit 130 determines that the display form to be used when displaying images in the image group is the panorama display form. FIG. 5 shows an example of the panorama display form. A panorama display form 500 has an overlapped similar region display area 510 and a thumbnail display area 520. The overlapped similar region display area 510 is an area for displaying the images included in the wide capture range image group with the similar regions of the images overlapping each other. The thumbnail display area 520 is an area for displaying thumbnail images of the images included in the confirmation image group. Note that an image 521 selected by the user in the thumbnail display area 520 is displayed in an emphasized manner as an image 511 at the front in the overlapped similar region display area 510.

In step S403, the display form determination unit 130 determines whether or not the image group is a same subject tracking image group. If it was determined that the image group is a same subject tracking image group (step S403: YES), the procedure moves to step S404. On the other hand, if it was determined that the image group is not a same subject tracking image group (step S403: NO), the procedure moves to step S405.

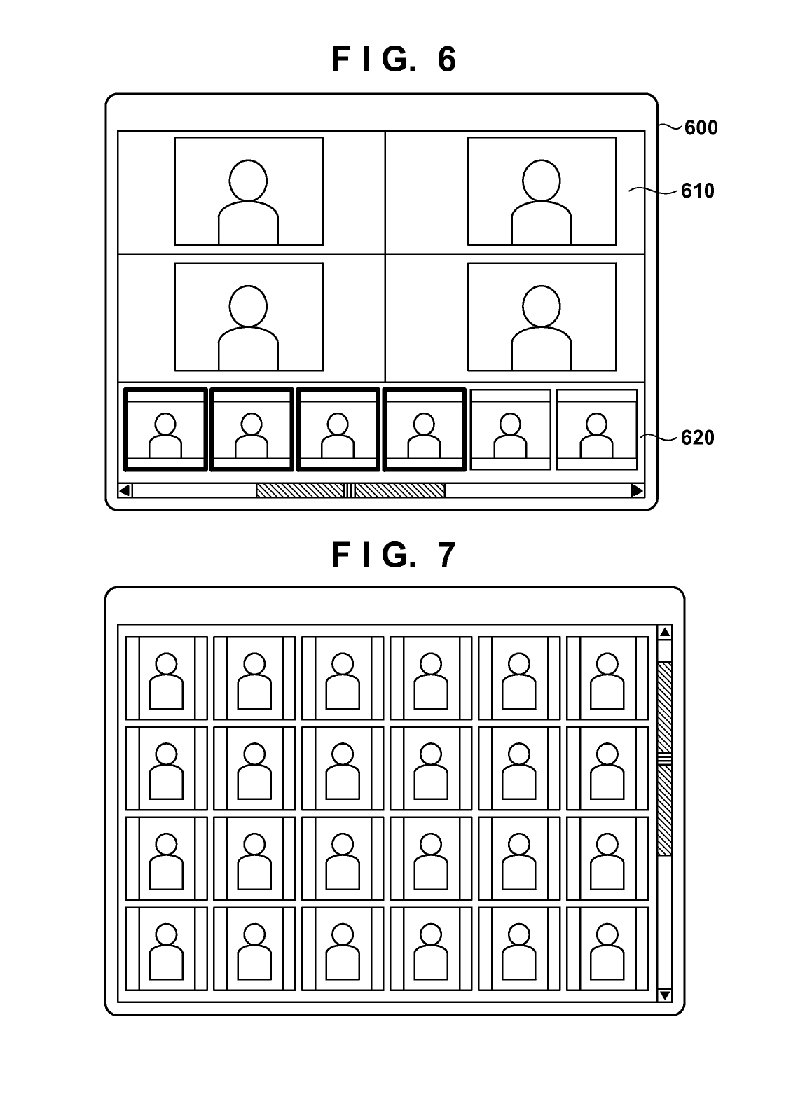

In step S404, the display form determination unit 130 determines that the display form to be used when displaying images in the image group is the comparison display form. FIG. 6 shows an example of the comparison display form. A comparison display form 600 has a comparison display area 610 and a thumbnail display area 620. The comparison display area 610 is an area for displaying multiple images including the selected image side-by-side. Note that although four images are displayed side-by-side in the example in FIG. 6, the number of images that are displayed side-by-side is not limited to four. The thumbnail display area 620 is an area for displaying the confirmation image group. Note that the image selected in the thumbnail display area 620 is displayed (in an emphasized manner) in the comparison display area 610.

In step S405, the display form determination unit 130 determines that the display form to be used when displaying images in the image group is the tabular display form. FIG. 7 shows an example of the tabular display form. In the example in FIG. 7, multiple images of the same size are displayed in a vertical and horizontal array. After the processing of step S402, S404, or S405 has been performed, the processing in the flowchart of FIG. 4 ends.

As described above, according to the present invention, by analyzing the inter-image relation between images that belong to each image group and discriminating a feature of each image group, it is possible to display each image group in an appropriate display form when displaying images that belong to an image group.

This makes it possible to automatically change the display form to a desired display form when the user selects an image, thus enabling improving the task efficiency for the user.

### Second Embodiment

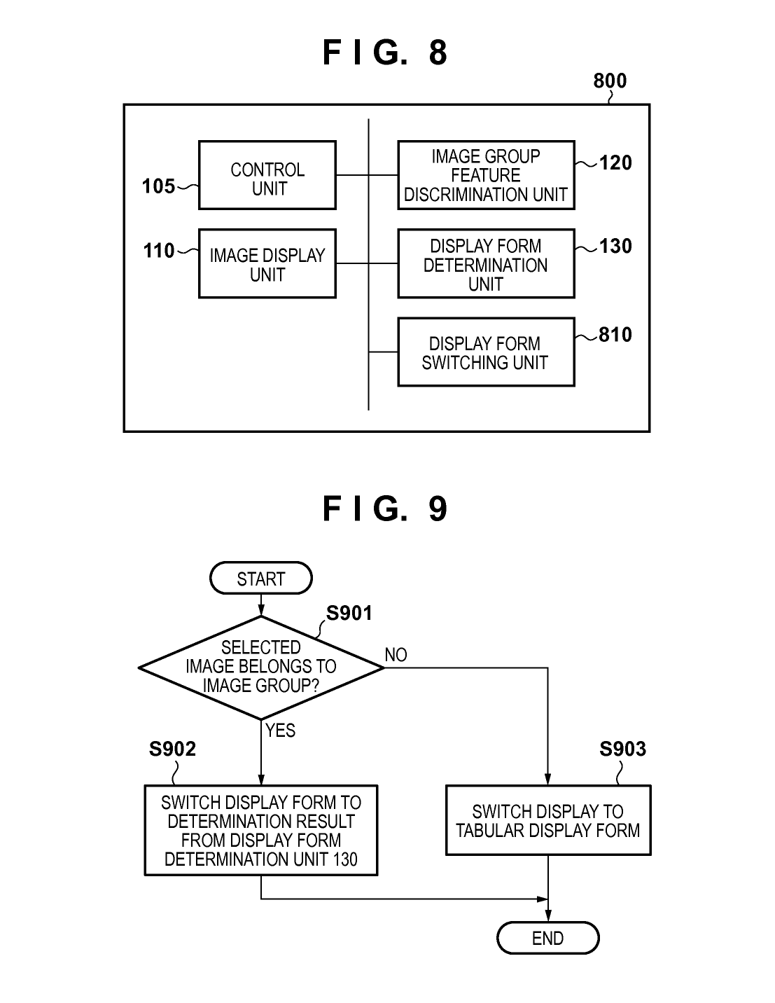

FIG. 8 is a diagram showing an example of the functional configuration of an image display apparatus 800 according to a second embodiment of the present invention. The image display apparatus 800 includes a display form switching unit 810 in addition to the configuration described in the first embodiment. If multiple image groups are included in the confirmation image group, the image display form is switched using the display form switching unit 810. When the user selects an image being displayed by the image display unit 110, the display form switching unit 810 switches the display form to the display form that corresponds to the image group to which the selected image belongs based on the result obtained by the display form determination unit 130.

Processing of Display Form Switching Unit 810

Next, the processing performed by the display form switching unit 810 will be described in detail. The display form switching unit 810 performs processing for switching the display form of the image display unit 110 using the display form determined by the display form determination unit 130. FIG. 9 is a flowchart showing a procedure of processing for switching the display when the user selects an image displayed by the image display unit 110.

First, in step S901, the display form switching unit 810 determines whether or not the image selected by the user belongs to any image group. If it was determined that the selected image belongs to an image group (step S901: YES), the procedure moves to step S902. On the other hand, if it was determined that the selected image does not belong to an image group (step S901: NO), the procedure moves to step S903.

In step S902, the display form switching unit 810 switches the display of the image display unit 110 in accordance with the display form of the image group to which the selected image belongs based on the determination result obtained by the display form determination unit 130. In step S903, the display form switching unit 810 switches the display form of the image display unit 110 to the tabular display form. After the processing of step S902 or step S903 has been performed, the processing in the flowchart of FIG. 9 ends.

As described above, according to the present embodiment, when the user selects an image being displayed by the image display unit, the image display form is switched based on the determination result obtained by the display form determination unit, thus making it possible to further improve the task efficiency for the user.

### Third Embodiment

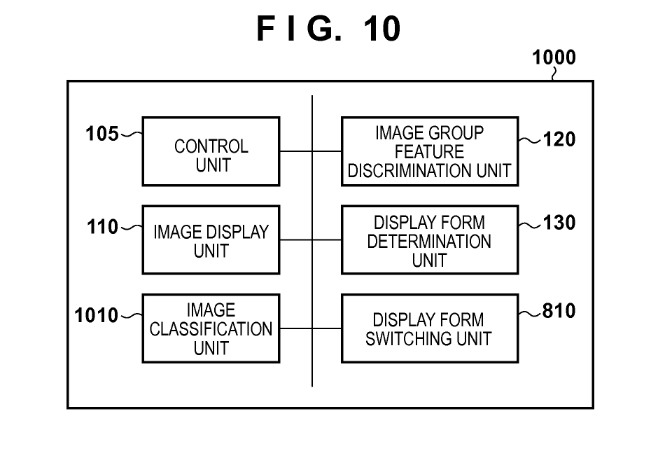

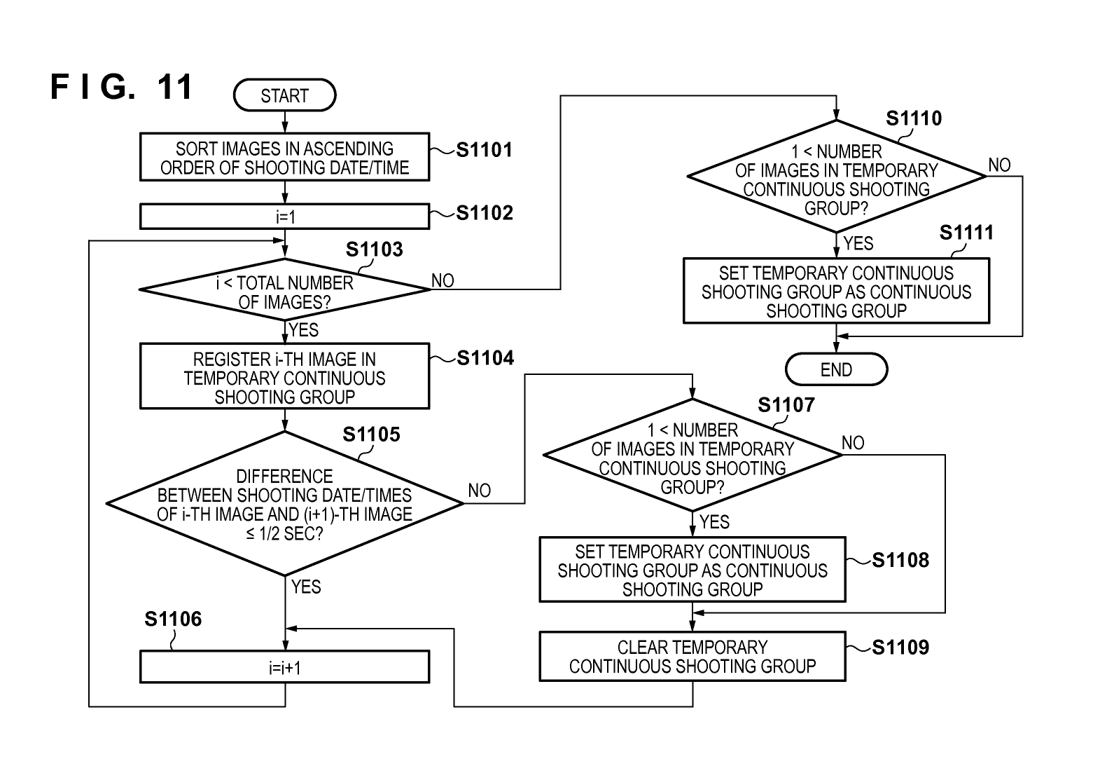

FIG. 10 is a diagram showing an example of the functional configuration of an image display apparatus 1000 according to a third embodiment of the present invention. The image display apparatus 1000 includes an image classification unit 1010 in addition to the configuration described in the second embodiment.

If no image groups are included in the confirmation image group, the images included in the confirmation image group are classified into groups using the image classification unit 1010. The image classification unit 1010 executes processing for classifying images into groups. The groups referred to here include a group of images that were captured under the condition that the shooting date/times or locations are similar based on shooting information attached to the images, or a group of images that have a common item in the information attached to the images.

Processing of Image Classification Unit 1010

Next, the processing performed by the image classification unit 1010 will be described in detail. The image classification unit 1010 performs processing for classifying images in any image group into groups. FIG. 11 is a flowchart showing a procedure of processing for classifying images obtained by continuous shooting. Note that although FIG. 11 will be described taking the example of classifying continuously shot images, the criterion for grouping is of course not limited to continuous shooting. For example, in the case of performing fixed point observation at multiple locations, the criterion may be that the location and shooting interval are constant.

First, in step S1101, the image classification unit 1010 sorts the images in the confirmation image group in ascending order of shooting date/time. Thereafter, in step S1102, the image classification unit 1010 sets the value of a file scan counter i to 1.

In step S1103, the image classification unit 1010 determines whether or not the value of the counter i is smaller than the total number of images in the confirmation image group. If it was determined that the value of i is smaller than the total number of images (step S1103: YES), the procedure moves to step S1104. On the other hand, if it was determined that the value of i is not smaller than the total number of images (step S1103: NO), the procedure moves to step S1110.

In step S1104, the i-th image (i being the value of the counter i) in the sorted confirmation image group is registered in a temporary continuous shooting group by the image classification unit 1010.

Next, in step S1105, the image classification unit 1010 determines whether or not the difference between the shooting date/times of the i-th image and the (i+1)-th image (i being the value of the counter i plus 1) is less than or equal to ½ seconds. If it was determined that the difference between the shooting date/times is less than or equal to ½ seconds (step S1105: YES), the procedure moves to step S1106. On the other hand, if it was determined that the difference between the shooting date/times is greater than ½ seconds (step S1105: NO), the procedure moves to step S1107. In step S1106, the image classification unit 1010 adds 1 to the value of the counter i. Note that after the processing of step S1106 has been performed, the procedure returns to the processing of step S1103.

In step S1107, the image classification unit 1010 determines whether or not the number of images that belong to the temporary continuous shooting group is larger than 1. If it was determined that the number of images that belong to the temporary continuous shooting group is larger than 1 (step S1107: YES), the procedure moves to step S1108. On the other hand, if it was determined that the number of images that belong to the temporary continuous shooting group is not larger than 1 (step S1107: NO), the procedure moves to step S1109. In step S1108, the image classification unit 1010 sets the image group that belongs to the temporary continuous shooting group as a continuous shooting group. In step S1109, the image classification unit 1010 clears the temporary continuous shooting group. After the processing of step S1109 has been performed, the above-described processing of step S1106 is performed, and then the procedure moves to the processing of step S1103.

In step S1110, the image classification unit 1010 determines whether or not the number of images that belong to the temporary continuous shooting group is larger than 1. If it was determined that the number of images that belong to the temporary continuous shooting group is larger than 1 (step S1110: YES), the procedure moves to step S1111. On the other hand, if it was determined that the number of images that belong to the temporary continuous shooting group is less than or equal to 1 (step S1110: NO), the processing ends.

In step S1111, the image classification unit 1010 sets the image group that belongs to the temporary continuous shooting group as a continuous shooting group, and ends the processing. This completes the processing of the flowchart in FIG. 11.

As described above, according to the present embodiment, even if no image groups are included in the confirmation image group, the images included in the confirmation image group are classified into groups using the image classification unit, thus making it possible to generate image groups.

The present invention makes it possible to alleviate the operation load borne by the user and improving the task efficiency when selecting an image from among a large number of images.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-106591 filed on May 20, 2013, which is hereby incorporated by reference herein in its entirety.

1. A display control apparatus comprising:
a discrimination unit configured to discriminate a feature of an image group based on a relation between images that belong to the image group;
a determination unit configured to determine a display form for the image group according to the feature discriminated by the discrimination unit; and
a display control unit configured to cause the image group to be displayed in the display form determined by the determination unit.

2. The display control apparatus according to claim 1,
wherein the discrimination unit discriminates the feature of the image group based on inter-image pixel difference information regarding images that belong to the image group.

3. The display control apparatus according to claim 1,
wherein the discrimination unit discriminates the feature of the image group based on the presence or absence of an inter-image similar region in images that belong to the image group.

4. The display control apparatus according to claim 1, further comprising:
a selection unit configured to receive a selection of an image; and
a switching unit configured to switch the display form to a display form that corresponds to the image group to which the image selected by the selection unit belongs,
wherein the display control unit causes the image to be displayed in the display form switched to by the switching unit.

5. The display control apparatus according to claim 1, further comprising:
a classification unit configured to classify a plurality of images into an image group based on shooting information of the plurality of images.

6. The display control apparatus according to claim 1,
wherein the display form of the image group includes a panorama display form in which images are displayed in an overlapping manner, a comparison display form in which a plurality of selected images are displayed side-by-side, and a tabular display form in which a plurality of images are displayed tabulated in a vertical and horizontal array.

7. The display control apparatus according to claim 6,
wherein in a case of the panorama display form, the display control unit causes display of an overlapped similar region display area in which images included in a wide capture range image group are displayed with similar regions of the images overlapping each other, and a thumbnail display area in which thumbnail images of the images are displayed.

8. The display control apparatus according to claim 6,
wherein in a case of the comparison display form, the display control unit causes display of a comparison display area in which a plurality of images that include a user-selected image are displayed side-by-side, and a thumbnail display area in which thumbnail images of the images are displayed.

9. A control method of a display control apparatus comprising the steps of:
discriminating a feature of an image group based on a relation between images that belong to the image group;
determining a display form for the image group according to the feature that was discriminated; and
causing the image group to be displayed in the display form that was determined.

10. A non-transitory computer-readable storage medium storing a computer program for causing a computer to execute the steps of a control method of a display control apparatus comprising the steps of:
discriminating a feature of an image group based on a relation between images that belong to the image group;
determining a display form for the image group according to the feature that was discriminated; and
causing the image around to be displayed in the display form that was determined.

11. A display control apparatus comprising:
a discrimination unit configured to discriminate a relation between images that belong to an image group based on difference information regarding the images;
a determination unit configured to determine a display form for the image group according to the difference information discriminated by the discrimination unit; and
a display control unit configured to cause the image group to be displayed in the display form determined by the determination unit.

12. A display control apparatus comprising:
a discrimination unit configured to discriminate a relation between images that belong to an image group; and
a display control unit configured to cause the image group to be displayed with similar regions of the images overlapping each other according to the relation discriminated by the discrimination unit.
